(19) United States
(12) Patent Application Publication
(10) Pub. No.: US 2026/0326305 A1
(43) Pub. Date: Oct. 22, 2026

(54) METHOD AND APPARATUS FOR TRACKING POSE OF NON-RIGID OBJECT IN MANIPULATOR SYSTEM

(71) Applicants: Hyundai Motor Company, Seoul (KR); Kia Corporation, Seoul (KR)

(72) Inventors: Sangyun Lee, Hwaseong (KR); Dongheon Shin, Hwaseong (KR); Su Hyun Yoon, Hwaseong (KR); Jaeseon Kim, Hwaseong (KR); Sunwoo Lee, Hwaseong (KR)

(21) Appl. No.: 19/352,228

(22) Filed: Oct. 7, 2025

(30) Foreign Application Priority Data
Apr. 18, 2025 (KR) 10- 2025-0050959

(51) Int. Cl. B25J 9/16; B25J 19/02; G06T 7/11; G06T 7/50

(52) U.S. Cl. CPC B25J 9/1697; B25J 19/023; G06T 7/11; G06T 7/50; G06T 2207/10028

(57) ABSTRACT

An embodiment of the present disclosure provides a method for tracking a pose of a non-rigid object in a manipulator system, including determining detection information for a non-rigid object based on at least one image data acquired using at least one camera included in a manipulator, determining matching depth information for the non-rigid object based on the acquired at least one image data, determining initial pose information for the non-rigid object based on the detection information and the matching depth information, and tracking a pose of the non-rigid object based on a geometric correspondence between the initial pose information for the non-rigid object and virtual 3D model information for the non-rigid object that has been previously stored.

### CROSS-REFERENCE TO RELATED APPLICATION

This present application claims, under 35 U.S.C. § 119(a), the benefit of Korean Patent Application No. 10-2025-0050959, filed Apr. 18, 2025, in the Korean Intellectual Property Office, the entire contents of which are incorporated herein by reference.

### BACKGROUND

### (a) Technical Field

The disclosure relates to a method and apparatus for tracking a pose of a non-rigid object in a manipulator system.

### (b) Background

A manipulator indicates a mechanism that accurately picks up or holds an object and moves it to a desired position in a robot or automated system, and is used in various fields such as, e.g., fields involving industrial robots, medical robots, logistics and delivery robots, space and military robots, and service robots. Meanwhile, in order to accurately pick up or grasp an object using a manipulator, accurate pose tracking of the object is essential.

However, according to conventional technologies, a CAD-based 6DoF (degree of freedom) pose tracking method has been generally developed for a rigid body, and therefore has a limitation in that accuracy and velocity of pose tracking for a non-rigid object whose shape or form is easily deformed by an external force are low.

Accordingly, there is a need to develop a pose tracking technologies capable of improving the accuracy and velocity of pose tracking for a non-rigid object in a real environment where a manipulator is operated.

### SUMMARY

The present disclosure attempts to provide a non-rigid object pose tracking method capable of improving accuracy and velocity of 6DoF pose tracking of a non-rigid object by estimating an initial pose based on segmentation of the non-rigid object that may be easily deformed by an external force and applying an ICG algorithm.

In addition, the present disclosure attempts to determine a failure point for pose tracking of a non-rigid object by considering an overlap ratio between a segmentation image for the non-rigid object and a rendering image determined by a virtual 3D model.

Technical objects desired to be achieved in the present disclosure are not limited to the aforementioned objects, and other technical objects not described above will be apparent to those skilled in the art from the disclosure of the present disclosure.

An embodiment of the present disclosure provides a method for tracking a pose of a non-rigid object in a manipulator system, including determining detection information for a non-rigid object based on at least one image data acquired using at least one camera included in a manipulator, determining matching depth information for the non-rigid object based on the acquired at least one image data, determining initial pose information for the non-rigid object based on the detection information and the matching depth information, and tracking a pose of the non-rigid object based on a geometric correspondence between the initial pose information for the non-rigid object and virtual 3D model information for the non-rigid object that has been previously stored.

The determining of the detection information may include determining detection information for the non-rigid object using an object detection model.

The detection information may include at least one of a bounding box, a class label, a confidence score, or a segmentation mask for the non-rigid object.

The determining of the detection information for the non-rigid object using the object detection model includes extracting a plurality of feature maps having different resolutions from the at least one image data, and outputting at least one of the bounding box, the class label, the confidence score, or the segmentation mask from the feature maps.

If the non-rigid object is not detected from the at least one image data, the determining of the detection information may include adjusting a position of the manipulator, and determining the detection information from at least one image data obtained based on an adjustment of the position of the manipulator.

The determining of the matching depth information may include determining RGB image data and depth image data for the non-rigid object from the at least one image data, and determining the matching depth information based on image matching of the RGB image data and the depth image data.

The determining of the matching depth information based on the image matching of the RGB image data and the depth image data may include converting the depth image data based on a coordinate system of the RGB image data, and aligning depth image data closest to the non-rigid object among the converted depth image data to the RGB image data.

The determining of the initial pose information for the non-rigid object may include determining an initial 3D point cloud for the non-rigid object and an initial normal vector for a surface formed by the initial 3D point cloud based on matching of the detection information and the matching depth information.

The tracking of the pose of the non-rigid object may include determining a feature point and a normal vector geometrically corresponding to the initial pose information based on the virtual 3D model information, and tracking the pose of the non-rigid object by referring to a rendered image determined based on the feature point and the normal vector.

The determining of the feature point and the normal vector geometrically corresponding to the initial pose information based on the virtual 3D model information may include determining the feature point and the normal vector using an iterative corresponding geometry (ICG) algorithm that optimizes geometric correspondence based on RGB-based matching and depth-based matching.

The tracking of the pose of the non-rigid object by referring to the rendered image determined based on the feature point and the normal vector determining a segmentation image for the non-rigid object based on rendering of the detection information, determining an overlap ratio between the segmentation image and the rendered image, and re-determining detection information for the non-rigid object when the overlap ratio is less than a predetermined threshold.

Another embodiment of the present disclosure provides an apparatus for tracking a pose of a non-rigid object in a manipulator system, including a memory configured to store a non-rigid object pose tracking program, and a processor configured to execute the non-rigid object pose tracking program by loading the non-rigid object pose tracking program from the memory, and the processor may be configured to determine detection information for a non-rigid object based on at least one image data acquired using at least one camera included in a manipulator, to determine matching depth information for the non-rigid object based on the acquired at least one image data, to determine initial pose information for the non-rigid object based on the detection information and the matching depth information, and to track a pose of the non-rigid object based on a geometric correspondence between the initial pose information for the non-rigid object and virtual 3D model information for the non-rigid object that has been previously stored.

The processor may be configured to determine detection information for the non-rigid object using an object detection model, and the detection information may include at least one of a bounding box, a class label, a confidence score, or a segmentation mask for the non-rigid object.

If the non-rigid object is not detected from the at least one image data, the processor may be configured to adjust a position of the manipulator, and to determine the detection information from at least one image data obtained based on an adjustment of the position of the manipulator.

The processor may be configured to determine RGB image data and depth image data for the non-rigid object from the at least one image data, and to determine the matching depth information based on image matching of the RGB image data and the depth image data.

The processor may be configured to convert the depth image data based on a coordinate system of the RGB image data, and to align depth image data closest to the non-rigid object among the converted depth image data to the RGB image data.

The processor may be configured to determine an initial 3D point cloud for the non-rigid object and an initial normal vector for a surface formed by the initial 3D point cloud based on matching of the detection information and the matching depth information.

The processor may be configured to determine a feature point and a normal vector geometrically corresponding to the initial pose information based on the virtual 3D model information, and to track the pose of the non-rigid object by referring to a rendered image determined based on the feature point and the normal vector.

The processor may be configured to determine the feature point and the normal vector using an iterative corresponding geometry (ICG) algorithm that optimizes geometric correspondence based on RGB-based matching and depth-based matching.

The processor may be configured to determine a segmentation image for the non-rigid object based on rendering of the detection information, to determine an overlap ratio between the segmentation image and the rendered image, and to re-determine detection information for the non-rigid object when the overlap ratio is less than a predetermined threshold.

Another embodiment provides a computer program stored on a computer-readable recording medium, the computer program, when executed by a processor, has instructions for causing the processor to perform a mobility driving control method, including determining detection information for a non-rigid object based on at least one image data acquired using at least one camera included in a manipulator, determining matching depth information for the non-rigid object based on the acquired at least one image data, determining initial pose information for the non-rigid object based on the detection information and the matching depth information, and tracking a pose of the non-rigid object based on a geometric correspondence between the initial pose information for the non-rigid object and virtual 3D model information for the non-rigid object that has been previously stored.

According to an embodiment, by determining detection information for a non-rigid object having a shape that is easily changed by an external force or a surrounding environment in real time using an object detection model, accuracy of pose tracking for the non-rigid object may be improved.

According to an embodiment, by aligning the depth image data closest to the non-rigid object with the RGB image data and removing other noise, it may be possible to enhance detection performance for the non-rigid object.

In addition, in according to the disclosure, an optimization error for matching with a virtual 3D model may be reduced by determining feature points and normal vectors geometrically corresponding to initial pose information using both the region-based modality and the depth-based modality in an ICG algorithm, so a unique effect of enabling faster and more accurate pose tracking for a non-rigid object may be achieved.

Furthermore, according to an embodiment, it may be possible to enable a tracking failure point to be clearly determined based on the overlap ratio between a segmentation image for a detected non-rigid object and a rendered image determined based on a feature point and a normal vector of a virtual 3D model.

According to an aspect of the present disclosure, a method for tracking a pose of a non-rigid object in a manipulator system is provided. The method may comprise determining detection information for a non-rigid object based on at least one image data, determining matching depth information for the non-rigid object based on the acquired at least one image data, determining initial pose information for the non-rigid object based on the detection information and the matching depth information, and tracking a pose of the non-rigid object.

According to an exemplary embodiment, the at least one image data may be acquired using at least one camera included in a manipulator, the determining the detection information may comprise determining detection information for the non-rigid object using an object detection model, and the detection information may comprise one or more of a bounding box, a class label, a confidence score, and a segmentation mask for the non-rigid object.

According to an exemplary embodiment, the determining the detection information for the non-rigid object using the object detection model may comprise extracting a plurality of feature maps having different resolutions from the at least one image data, and outputting one or more of: the bounding box; the class label; the confidence score; and the segmentation mask from the feature maps.

According to an exemplary embodiment, when the non-rigid object is not detected from the at least one image data, the determining the detection information may comprise adjusting a position of a manipulator, and determining the detection information from at least one image data obtained based on an adjustment of the position of the manipulator.

According to an exemplary embodiment, the determining the matching depth information may comprise determining RGB image data and depth image data for the non-rigid object from the at least one image data and determining the matching depth information based on image matching of the RGB image data and the depth image data.

According to an exemplary embodiment, the determining the matching depth information based on the image matching of the RGB image data and the depth image data may comprise converting the depth image data based on a coordinate system of the RGB image data, and aligning depth image data closest to the non-rigid object among the converted depth image data to the RGB image data.

According to an exemplary embodiment, the determining the initial pose information for the non-rigid object may comprise determining an initial 3D point cloud for the non-rigid object and an initial normal vector for a surface formed by the initial 3D point cloud based on matching of the detection information and the matching depth information.

According to an exemplary embodiment, the tracking the pose of the non-rigid object may comprise tracking the pose of the non-rigid object based on a geometric correspondence between the initial pose information for the non-rigid object and virtual 3D model information for the non-rigid object that has been previously stored, determining a feature point and a normal vector geometrically corresponding to the initial pose information based on the virtual 3D model information, and tracking the pose of the non-rigid object by referring to a rendered image determined based on the feature point and the normal vector.

According to an exemplary embodiment, the determining the feature point and the normal vector geometrically corresponding to the initial pose information based on the virtual 3D model information may comprise determining the feature point and the normal vector using an iterative corresponding geometry (ICG) algorithm that optimizes geometric correspondence based on RGB-based matching and depth-based matching.

According to an exemplary embodiment, the tracking the pose of the non-rigid object by referring to the rendered image determined based on the feature point and the normal vector may comprise determining a segmentation image for the non-rigid object based on rendering of the detection information, determining an overlap ratio between the segmentation image and the rendered image, and re-determining detection information for the non-rigid object when the overlap ratio is less than a predetermined threshold.

According to an aspect of the present disclosure, an apparatus for tracking a pose of a non-rigid object in a manipulator system is provided. The apparatus may comprise a computing device comprising a processor and a memory. The memory may be configured to store instructions that, when executed by the processor, are configured to cause the processor to determine detection information for a non-rigid object based on at least one image data, determine matching depth information for the non-rigid object based on the acquired at least one image data, determine initial pose information for the non-rigid object based on the detection information and the matching depth information, and track a pose of the non-rigid object.

According to an exemplary embodiment, the at least one image data may be acquired using at least one camera included in a manipulator, the computing device may be configured to determine detection information for the non-rigid object using an object detection model, and the detection information may comprise one or more of: a bounding box; a class label; a confidence score; and a segmentation mask for the non-rigid object.

According to an exemplary embodiment, when the non-rigid object is not detected from the at least one image data, the computing device may be configured to adjust a position of a manipulator, and determine the detection information from at least one image data obtained based on an adjustment of the position of the manipulator.

According to an exemplary embodiment, the computing device may be configured to determine RGB image data and depth image data for the non-rigid object from the at least one image data, and determine the matching depth information based on image matching of the RGB image data and the depth image data.

According to an exemplary embodiment, the computing device may be configured to convert the depth image data based on a coordinate system of the RGB image data, and align depth image data closest to the non-rigid object among the converted depth image data to the RGB image data.

According to an exemplary embodiment, the computing device may be configured to determine an initial 3D point cloud for the non-rigid object and an initial normal vector for a surface formed by the initial 3D point cloud based on matching of the detection information and the matching depth information.

According to an exemplary embodiment, the computing device may be configured to track the pose of the non-rigid object based on a geometric correspondence between the initial pose information for the non-rigid object and virtual 3D model information for the non-rigid object that has been previously stored, determine a feature point and a normal vector geometrically corresponding to the initial pose information based on the virtual 3D model information, and track the pose of the non-rigid object by referring to a rendered image determined based on the feature point and the normal vector.

According to an exemplary embodiment, the computing device may be configured to determine the feature point and the normal vector using an iterative corresponding geometry (ICG) algorithm that optimizes geometric correspondence based on RGB-based matching and depth-based matching.

According to an exemplary embodiment, the computing device may be configured to determine a segmentation image for the non-rigid object based on rendering of the detection information, determine an overlap ratio between the segmentation image and the rendered image, and re-determine detection information for the non-rigid object when the overlap ratio is less than a predetermined threshold.

According to an aspect of the present disclosure, a non-transitory computer-readable recording medium is provided. The non-transitory computer-readable recording medium may storing a computer program that, when executed by a processor, has instructions for causing the processor to perform a mobility driving control method, comprising determining detection information for a non-rigid object based on at least one image data, determining matching depth information for the non-rigid object based on the acquired at least one image data, determining initial pose information for the non-rigid object based on the detection information and the matching depth information, and tracking a pose of the non-rigid object.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a block diagram showing a non-rigid object pose tracking apparatus, according to an exemplary embodiment of the present disclosure.

FIG. 2 illustrates a conceptual block diagram showing a function of a non-rigid object pose tracking program, according to an exemplary embodiment of the present disclosure.

FIG. 3 illustrates a flowchart showing a method for tracking a pose of a non-rigid object in a manipulator system, according to an exemplary embodiment of the present disclosure.

FIG. 4 illustrates an example of tracking a pose of a non-rigid object in consideration of a pose tracking failure in a manipulator system, according to an exemplary embodiment of the present disclosure.

FIG. 5 illustrates an example of determination of detection information for a non-rigid object using an object detection model, according to an exemplary embodiment of the present disclosure.

FIG. 6 illustrates an example of determination of matching depth information based on image matching of RGB image data and depth image data, according to an exemplary embodiment of the present disclosure.

FIG. 7 illustrates an example of showing a region modality and a depth modality used in an ICG algorithm, according to an exemplary embodiment of the present disclosure.

FIG. 8 illustrates an example of pose tracking of a non-rigid object based on geometric correspondence between initial pose information and virtual 3D model information, according to an exemplary embodiment of the present disclosure.

FIG. 9 illustrates an example of determination of a pose tracking failure for a non-rigid object, according to an exemplary embodiment of the present disclosure.

### DETAILED DESCRIPTION

Hereinafter, exemplary embodiments disclosed in the present document will be described in detail with reference to the accompanying drawings. Like reference numerals designate like elements, and redundant descriptions thereof will be omitted. Further, such as “module” and a “unit”, suffixes for components used in the following description are given or mixed and used by considering easiness in preparing a specification and do not have a meaning or role distinguished from each other in themselves. In addition, in describing an embodiment disclosed in the present document, if it is determined that a detailed description of a related art incorporated herein unnecessarily obscure the gist of the embodiment, the detailed description thereof will be omitted. Furthermore, it should be understood that the appended drawings are intended only to help understand embodiments disclosed in the present document and do not limit the technical principles and scope of the present disclosure; rather, it should be understood that the appended drawings include all of the modifications, equivalents or substitutes described by the technical principles and belonging to the technical scope of the present disclosure.

Although the terms first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

The advantages and features of the present disclosure and the methods for accomplishing the same will be apparent from the embodiments described hereinafter with reference to the accompanying drawings. However, the present disclosure is not limited to the embodiments and may be embodied in various other forms or examples. These embodiments are provided so that this disclosure will be thorough and complete, and will fully convey the scope of the present disclosure to those skilled in the art. The scope of the present disclosure is defined in the appended claims.

In the following description of embodiments of the present disclosure, when a detailed description of known configurations or functions may obscure the subject matter of the present disclosure, a detailed description thereof will be omitted. Then, the terms described below are terms defined in consideration of functions in embodiments of the present disclosure, and may vary depending on the intention or custom of a user or operator. Accordingly, the definition should be based on the contents throughout this specification.

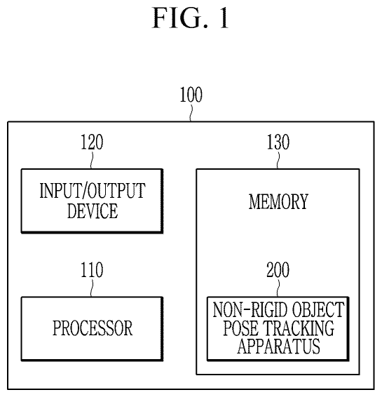

FIG. 1 illustrates a block diagram showing a non-rigid object pose tracking apparatus, according to an exemplary embodiment of the present disclosure.

Referring to FIG. 1, the non-rigid object pose tracking apparatus 100 may comprise a processor 110, an input/output device 120, and a memory 130. The object pose tracking apparatus 100 may be a form of computing device and/or be coupled to a computing device. The member 130 may be configured to store instructions that, when executed by the processor 110, are configured to cause the processor 110 to perform one or more processes/steps according to the present disclosure.

The controller 110 may be configured to generally control an operation of the non-rigid object pose tracking apparatus 100.

The processor 110 may be configured to receive at least one image data including a non-rigid object using the input/output device 120.

Specifically, the processor 110 may be configured to receive image data (e.g., depth image data, depth video data, RGB image data, RGB video data, IR image data, IR video data, etc.) formed of at least one frame for a non-rigid object from at least one image acquired using at least one camera (e.g., a stereo camera, an RGB-D camera, etc.) included in the manipulator.

In this specification, for better understanding and ease of description, it has been described that at least one image data including the non-rigid object, or image data formed of one or more frames of the non-rigid object, is input through the input/output device 120, but the present disclosure is not limited thereto. That is, according to an exemplary embodiment, the non-rigid object pose tracking apparatus 100 may comprise a transceiver (not shown), and the non-rigid object pose tracking apparatus 100 may be configured to receive at least one of image data including the non-rigid object or image data formed of at least one frame for the non-rigid object using the transceiver (not shown), and at least one of the image data including the non-rigid object or the image data formed of at least one frame for the non-rigid object may be collected or generated within the non-rigid object pose tracking apparatus 100.

The processor 110 may be configured to determine detection information and matching depth information for a non-rigid object from at least one image data acquired through at least one camera, determine initial pose information for the non-rigid object based on the detection information and the matching depth information, and track the pose for the non-rigid object based on a geometric correspondence between the initial pose information for the non-rigid object and virtual 3D model information.

The input/output device 120 may comprise one or more input devices and/or one or more output devices. For example, the input devices may comprise a microphone, a keyboard, a mouse, a touch screen, etc., and the output devices may comprise a display, speaker, etc.

The memory 130 may be configured to store a non-rigid object pose tracking program 200 and information necessary for executing the non-rigid object pose tracking program 200.

In this specification, the non-rigid object pose tracking program 200 may be configured to indicate software including commands for tracking a pose for a non-rigid object based on a geometric correspondence between initial pose information for the non-rigid object determined based on at least one image data acquired through at least one camera included in a manipulator and virtual 3D model information about the non-rigid object.

The processor 110 may be configured to load the non-rigid object pose tracking program 200 and information necessary for executing the non-rigid object pose tracking program 200 from the memory 130 to execute the non-rigid object pose tracking program 200.

The processor 110 may be configured to determine detection information for a non-rigid object based on at least one image data acquired using at least one camera included in the manipulator, determine matching depth information for the non-rigid object based on the acquired at least one image data, determine initial pose information for the non-rigid object based on the detection information and the matching depth information, and track the pose of the non-rigid object based on a geometric correspondence between the initial pose information for the non-rigid object and previously stored virtual 3D model information for the non-rigid object.

According to an exemplary embodiment of the present disclosure, the manipulator system may comprise a system configured for performing environmental recognition and feedback control of the manipulator, capable of performing object tracking control or object grasping control for the manipulator based on information processed using a camera and image processing.

According to an exemplary embodiment of the present disclosure, the non-rigid object may comprise an object having a shape or form that is easily deformed by an external force or a surrounding environment, and may include, e.g., a non-rigid body (e.g., a rubber ball, a cloth, a candy bag, etc.) or a soft body (e.g., jelly, balloon, sponge, etc.).

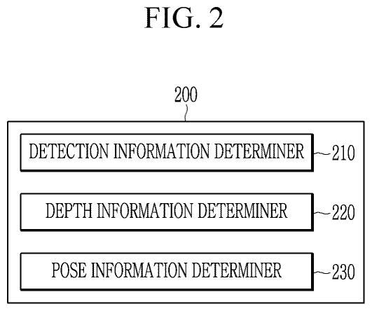

Functions and/or operations of the non-rigid object pose tracking program 200 will be described in detail with reference to FIG. 2.

FIG. 2 illustrates a conceptual block diagram showing a function of a non-rigid object pose tracking program, according to an exemplary embodiment of the present disclosure.

Referring to FIG. 2, the non-rigid object pose tracking program 200 may comprise a detection information determiner 210, a depth information determiner 220, and a pose information determiner 230.

The detection information determiner 210, the depth information determiner 220, and the pose information determiner 230 illustrated in FIG. 2 may comprise elements that are conceptually divided according to the functions of the non-rigid object pose tracking program 200 to easily describe the functions of the non-rigid object pose tracking program 200, but the present disclosure is not limited thereto. According to embodiments, the functions of the detection information determiner 210, the depth information determiner 220, and the pose information determiner 230 may be merged or separated, and may be implemented as a series of instructions included in a single program.

First, the detection information determiner 210 may be configured to determine detection information for a non-rigid object based on at least one image data acquired using at least one camera included in the manipulator.

Specifically, the detection information determiner 210 may be configured to determine the detection information for the non-rigid object using an object detection model (e.g., an RTMDet model).

Herein, the detection information for the target object may refer to information corresponding to the outline and silhouette of the non-rigid object.

According to an exemplary embodiment, the detection information for the non-rigid object may comprise at least one of a bounding box, a class label, a confidence score, and a segmentation mask for the non-rigid object.

In addition, according to an embodiment, the object detection model may indicate a high-performance lightweight model for real-time object detection, and a structure of the object detection model may be formed of a backbone that enables multi-scale feature extraction, a neck that combines multi-scale features, and a head that detects and identifies an object.

For example, the detection information determiner 210 may be configured to input at least one image data into an RTMDet model to output detection information for a non-rigid object.

More specifically, the detection information determiner 210 may be configured to extract a plurality of feature maps with different resolutions from at least one image data.

According to an exemplary embodiment, the detection information determiner 210 may be configured to extract feature maps of different sizes, and may extract multiple feature maps with different resolutions through fusion of the feature maps of different sizes.

Additionally, the detection information determiner 210 may be configured to output at least one of a bounding box, a class label, a confidence score, or a segmentation mask from the multiple feature maps.

According to an exemplary embodiment, to output detection information for the non-rigid object, the detection information determiner 210 may be configured to enable reduced computational load and real-time processing by utilizing a detection head that efficiently shares parameters.

Meanwhile, if a non-rigid object is not detected from at least one image data, the detection information determiner 210 may be configured to transmit a manipulator position adjustment request signal to a manipulator system. Herein, the manipulator system may be configured to control adjustment of a position of the manipulator based on the position adjustment request signal.

Additionally, the detection information determiner 210 may be configured to determine detection information for the non-rigid object from at least one image data acquired based on adjustment of a position of the manipulator.

In this way, in the present disclosure, by determining detection information for a non-rigid object having a shape that is easily changed by an external force or a surrounding environment in real time using an object detection model, an effect of improving accuracy of pose tracking for the non-rigid object, which will be described later, may be achieved.

Meanwhile, a type of object detection model, according to an exemplary embodiment, is merely an example, and may be variously modified within a scope of achieving the purpose of the present disclosure.

Next, the depth information determiner 220 may be configured to determine matching depth information for the non-rigid object based on the at least one image data.

Herein, the matching depth information, according to an exemplary embodiment, may refer to data regarding a depth image in which a RGB image and a depth image are precisely aligned on a pixel-by-pixel basis, thereby assigning a depth value corresponding to each RGB pixel.

Specifically, the depth information determiner 220 may be configured to determine RGB image data and depth image data for a non-rigid object based on at least one image data.

For example, the depth information determiner 220 may be configured to determine depth image data for the non-rigid object based on the disparity map determined from a plurality of RGB image data acquired through a stereo camera.

As another example, the depth information determiner 220 may be configured to determine depth image data for a non-rigid object based on depth image data acquired through an RGB-D camera.

Additionally, the depth information determiner 220 may be configured to determine the matching depth information based on image matching for RGB image data and depth image data.

For example, the depth information determiner 220 may be configured to convert the depth image data based on a coordinate system of the RGB image data.

More specifically, the depth information determiner 220 may be configured to align the depth image data with the RGB image data using a camera matrix that includes parameters (e.g., intrinsic parameter and extrinsic parameter) of a camera acquiring RGB image data and a camera acquiring depth image data.

Additionally, the depth information determiner 220 may be configured to align depth image data closest to the non-rigid object among the converted depth image data to the RGB image data.

In this regard, according to coordinate system transformation of the depth image data, multiple depth values may be mapped to a same position coordinates in the RGB coordinate system, and among the multiple depth values, a depth value of the object closest to the camera may correspond to the depth value for the non-rigid object.

In this way, in the present disclosure, by aligning the depth image data closest to the non-rigid object with the RGB image data and removing other noise, the unique effect of enhancing detection performance for the non-rigid object may be achieved.

Next, the pose information determiner 230 may be configured to determine initial pose information for the non-rigid object based on the detection information and the matching depth information.

Herein, the initial pose information may be information indicating a position and a direction of the non-rigid object that is primarily estimated using detection information and matching depth information, and may comprise, e.g., a 6DoF pose.

Specifically, the detail information determiner 230 may be configured to determine an initial 3D point cloud (or 3D point set) for a non-rigid object and an initial normal vector for a surface formed by the initial 3D point cloud based on matching the detection information and matching depth information.

For example, the detail information determiner 230 may be configured to determine position coordinates of the initial 3D point cloud for the non-rigid object and the initial normal vector for the surface of the non-rigid object by matching a segmentation mask for the non-rigid object and a depth value corresponding to the segmentation mask.

Next, the pose information determiner 230 may be configured to track a pose of the non-rigid object based on a geometric correspondence between initial pose information for the non-rigid object and virtual 3D model information for the non-rigid object that has been previously stored.

Herein, the virtual 3D model information, according to an exemplary embodiment, may comprise a virtual 3D CAD model for any non-rigid object and a plurality of direction vectors for the virtual 3D CAD model, and the virtual 3D model information may be stored in an external database.

According to an exemplary embodiment, the direction vectors may be reconstructed based on 3D position coordinates and 3D normal vectors for a plurality of virtual 3D models (i.e., a plurality of viewpoint models) determined according to a plurality of viewpoints of a virtual camera.

Specifically, the pose information determiner 230 may be configured to determine a feature point and a normal vector geometrically corresponding to the initial pose information based on the virtual 3D model information.

More specifically, the detail information determiner 230 may be configured to determine the feature point and the normal vector using an iterative corresponding geometry (ICG) algorithm that optimizes geometric correspondence based on RGB-based matching and depth-based matching.

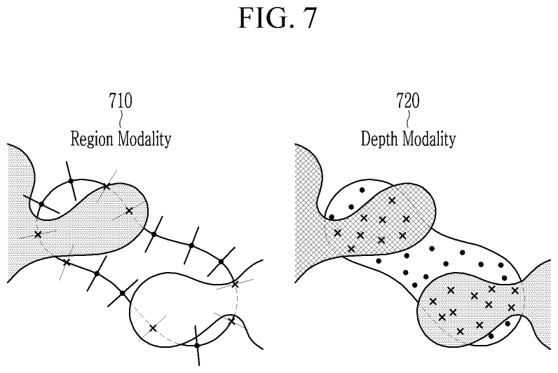

Meanwhile, the ICG algorithm that optimizes geometric correspondence based on RGB-based matching and depth-based matching will be described in detail with reference to FIG. 7.

Additionally, the pose information determiner 230 may track the pose of the non-rigid object by referring to a rendered image determined based on the feature point.

Meanwhile, the detail information determiner 230 may be configured to determine a segmentation image for a non-rigid object based on rendering of detection information (e.g., a bounding box and a segmentation mask).

Additionally, the detail information determiner 230 may be configured to determine an overlap ratio between the segmentation image and the rendered image.

Herein, if the overlap ratio is less than a predetermined threshold, the pose information determiner 230 may be configured to re-determine the detection information for the non-rigid object.

In this way, the present disclosure may achieve a unique effect of enabling a tracking failure point to be clearly determined based on the overlap ratio between a segmentation image for a detected non-rigid object and a rendered image determined based on a feature point and a normal vector of a virtual 3D model.

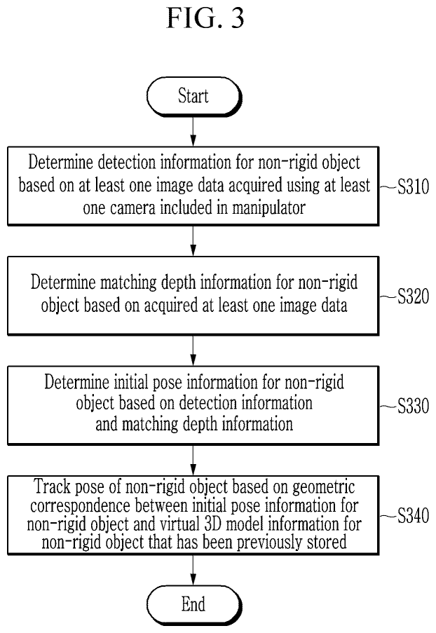

FIG. 3 illustrates a flowchart showing a method for tracking a pose of a non-rigid object in a manipulator system, according to an exemplary embodiment of the present disclosure.

Referring to FIG. 3, the detection information determiner 210 may be configured to determine detection information for a non-rigid object based on at least one image data acquired using at least one camera included in the manipulator (S310).

Next, the depth information determiner 220 may be configured to determine matching depth information for the non-rigid object based on the acquired at least one image data (S320).

Next, the pose information determiner 230 may be configured to determine initial pose information for the non-rigid object based on detection information and matching depth information (S330).

Next, the pose information determiner 230 may be configured to track a pose of the non-rigid object based on a geometric correspondence between initial pose information for the non-rigid object and virtual 3D model information for the non-rigid object that has been previously stored (S340).

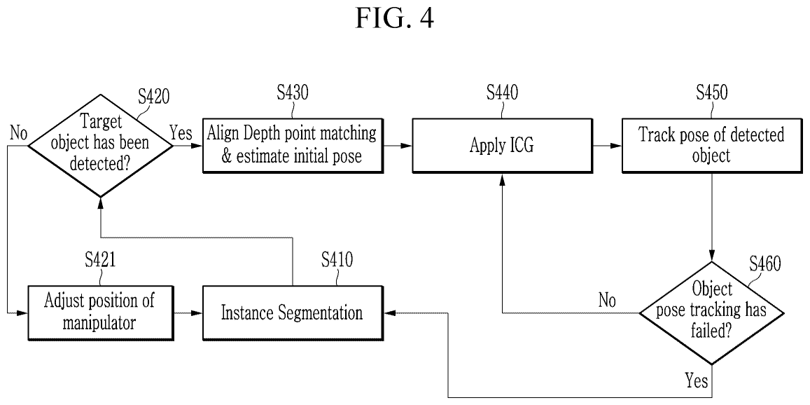

FIG. 4 illustrates an example of tracking a pose of an object in consideration of a pose tracking failure in a manipulator system, according to an exemplary embodiment of the present disclosure.

Referring to FIG. 4, the non-rigid object pose tracking apparatus 100 may be configured to determine detection information for an object based on segmentation of at least one image data acquired through at least one camera included in a manipulator (S410).

Next, the non-rigid object pose tracking apparatus 100 may be configured to determine whether a target object has been detected (S420).

If the target object is not detected, the manipulator system may be configured to adjust a position of the manipulator (S421). Herein, the target object may be re-detected through segmentation of image data acquired at an adjusted position of the manipulator.

Meanwhile, if the target object is detected, the non-rigid object pose tracking apparatus 100 may be configured to determine initial pose information for the object based on matching depth information and detection information (S430).

Next, the non-strength object pose tracking apparatus 100 may be configured to determine a direction vector that optimizes geometric correspondence to the initial pose information from a virtual 3D model information based on an ICG algorithm, and may be configured to determine a feature point and a normal vector corresponding to the direction vector (S440).

Next, the non-strength object pose tracking apparatus 100 may be configured to track a pose of the object by referring to a rendered image determined based on the feature point and the normal vector (S450).

Herein, the non-strength object pose tracking apparatus 100 may be configured to determine whether object pose tracking has failed based on an overlap ratio between the segmentation image for the object determined based on rendering for the detection information and the rendered image determined from the feature point and normal vector (S460).

In this case, if the object pose tracking fails, the non-rigid object pose tracking apparatus 100 may be configured to re-determine the detection information for the object.

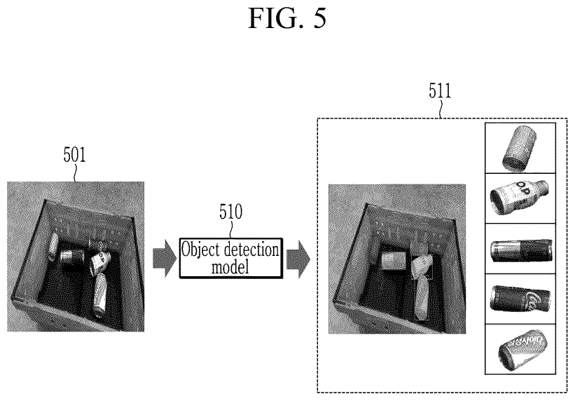

FIG. 5 illustrates an example of determination of detection information for a non-rigid object using an object detection model, according to an exemplary embodiment of the present disclosure.

Referring to FIG. 5, the detection information determiner 210 may be configured to input image data 501 including a plurality of cans whose original shapes have been partially deformed into an object detection model 510 to determine detection information 511 for the cans.

The detection information 511 for the cans may comprise information corresponding to outlines and silhouettes of the cans, and may comprise an RGB-based segmentation mask and bounding box.

In this way, by utilizing the RGB-based segmentation mask and bounding box, the present disclosure may enable accurate determination of initial pose information for a non-rigid object whose original shape may be partially deformed.

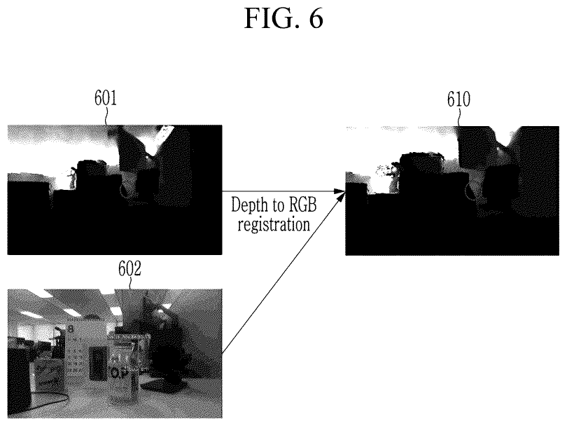

FIG. 6 illustrates an example of determination of matching depth information based on image matching of RGB image data and depth image data, according to an exemplary embodiment of the present disclosure.

Referring to FIG. 6, the depth information determiner 220 may be configured to accurately align the RGB image and the depth image on a pixel-by-pixel basis based on image matching for depth image data 601 and RGB image data 602 for a coffee can, to determine matching depth information 610 for a depth image to which a depth value corresponding to each RGB pixel is assigned.

Herein, depth information determiner 220 may be configured to convert the depth image data 601 based on a coordinate system of the RGB image data 602, and may be configured to align a closest depth value corresponding to the coffee can among the converted depth image data to the RGB image data.

FIG. 7 illustrates an example of showing a region modality and a depth modality used in an ICG algorithm, according to an exemplary embodiment of the present disclosure.

Referring to FIG. 7, the pose information determiner 230 may be configured to determine a feature point and a normal vector corresponding to initial detail information from virtual 3D model information using an ICG algorithm that optimizes geometric correspondence based on RGB-based matching and depth-based matching.

When pose information of a target object is given, the ICG algorithm, according to an exemplary embodiment of the present disclosure, may be configured to aim to estimate an optimal pose closest to the given pose information through repeated comparisons with multiple viewpoint models. In the ICG algorithm, either region-based modality 710 or depth-based modality 720 may be used independently.

First, the region-based modality 710 may be used to compare the viewpoint models based on characteristics of an outline and a surface of the estimated object.

More specifically, in a case of the region-based modality 710, objects corresponding to a same silhouette may be rendered with a same region ID, allowing characteristics of an outline of a non-rigid object to be considered sparsely.

Herein, valid points within the outline may be determined based on a validity assessment of whether they are the same region. In FIG. 7, it may be seen that valid points are indicated by circles and invalid points are indicated by crosses.

In this process, pixels of a line along a normal vector to a surface may be evaluated, and points of that outline may be evaluated as invalid if a distance to an interior is interrupted by another silhouette, or if the distance to the exterior is interrupted by a same silhouette.

Next, the depth-based modality 720 may be used to compare multiple viewpoint models based on characteristics of a depth of the estimated object.

More specifically, for the depth-based modality 720, according to an exemplary embodiment, all objects may be rendered with a unique value, and points on the surface that are not in the silhouette of the target object may be invalid.

According to the present disclosure, the pose information determiner 230 may be configured to estimate a position and direction (e.g., 6DoF pose) of a non-rigid object based on probabilistic optimization using the region-based modality 710 corresponding to RGB-based matching and the depth-based modality 720 corresponding to depth-based matching.

For example, a probability model using the region-based modality 710 and the depth-based modality 720 may be expressed as following Equation 1.

$$p ( θ \vert D ) = {\prod }_{i = 0}^{{n}_{r}} p ( θ \vert {w}_{si} , {l}_{i} ) {\prod }_{i = 0}^{{n}_{d}} p ( θ \vert {P}_{i} ) \qquad Equation 1$$

Herein, p(θ|D) may represent a posterior probability of pose θ given the given data D.

In addition,

$${\prod }_{i = 0}^{{n}_{r}} p ( θ \vert {w}_{si} , {l}_{i} )$$

may represent a product of individual probabilities of nᵣ corresponding lines derived from the region-based modality. Herein, p(θ|wₛᵢ, lᵢ) may represent a probability of pose θ in the region-based modality, given a valid point wₛᵢ and its position lᵢ.

In addition,

$${\prod }_{i = 0}^{{n}_{d}} p ( θ \vert {P}_{i} )$$

may represent a product of individual probabilities of n_{d} corresponding points derived from the depth-based modality. Herein, p(θ|Pᵢ) may represent a probability of pose θ in the depth-based modality, given a 3D point Pᵢ detected from depth information.

In this way, in the present disclosure, an optimization error for matching with a virtual 3D model may be reduced by determining feature points and normal vectors geometrically corresponding to initial pose information using both the region-based modality and the depth-based modality, so a unique effect of enabling faster and more accurate pose tracking for a non-rigid object may be achieved.

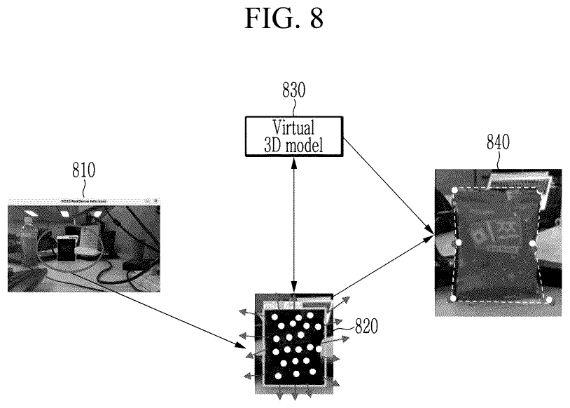

FIG. 8 illustrates an example of pose tracking of a non-rigid object based on geometric correspondence between initial pose information and virtual 3D model information, according to an exemplary embodiment of the present disclosure.

Referring to FIG. 8, the pose information determiner 230 may be configured to determine initial pose information 820 by matching a segmentation mask for a non-rigid object and a depth value corresponding to the segmentation mask from image data 810 including a non-rigid object.

Herein, the initial pose information 820 may comprise position coordinates of an initial 3D point cloud for a non-rigid object and an initial normal vector for a surface formed by the initial 3D point cloud.

Next, the pose information determiner 230 may be configured to determine the feature point and the normal vector by aligning the initial pose information 820 and a plurality of virtual 3D models 830 based on the ICG algorithm, and may be configured to track the pose of the non-rigid object by referring to a rendered image 840 determined from the feature point and the normal vector.

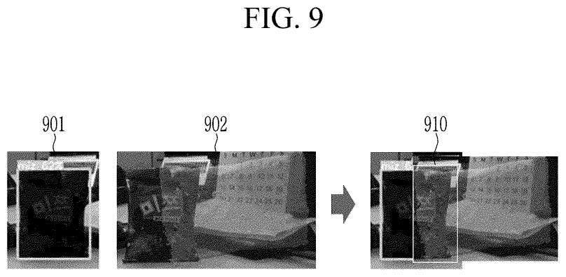

FIG. 9 illustrates an example of determination of a pose tracking failure for a non-rigid object, according to an exemplary embodiment of the present disclosure.

FIG. 9 illustrates a segmentation image 901 determined based on rendering for a non-rigid object and a rendered image 902 for an arbitrary non-rigid object.

Referring to FIG. 9, the pose information determiner 230 may be configured to determine an overlap ratio 910 between the segmentation image 901 and the rendered image 902.

Herein, if the overlap ratio is less than a predetermined threshold, the pose information determiner 230 may be configured to determine that pose tracking for a non-rigid object has failed.

Combinations of each block in the block diagrams and each operation in the flowcharts attached to the present disclosure may also be executed by computer program instructions. These computer program instructions may be embedded in an encoding processor of a general-purpose computer, a special-purpose computer, or other programmable data processing apparatus, and thus the instructions, when executed by the encoding processor of the computer or other programmable data processing apparatus, may create a means for performing the functions described in each block of the block diagram or each operation of the flowchart. These computer program instructions may also be stored in a computer-available or computer-readable memory capable of directing a computer or other programmable data processing apparatus to implement functions in a particular manner, so the instructions stored in the computer-available or computer-readable memory may also produce an article of manufacture that includes instruction means for performing the functions described in each block of the block diagram or each operation of the flowchart. The computer program instructions may also be installed on a computer or other programmable data processing apparatus, a series of operations may be performed on the computer or other programmable data processing apparatus to create a computer-executable process, and the instructions that cause the computer or other programmable data processing apparatus to perform the operations for executing the functions described in each block of the block diagram and each operation of the flowchart may also provide operations for executing the functions described in each block of the block diagram and each operation of the flowchart.

Additionally, each block or each operation may represent a module, segment or portion of code that contains one or more executable instructions for executing a particular logical function(s). It should also be noted that in some alternative embodiments, the functions mentioned in the blocks or operations may occur out of order. For example, two blocks or operations shown in succession may in fact be performed substantially simultaneously, or the blocks or operations may sometimes be performed in reverse order, depending on the functionality they serve.

The above description is merely illustrative of the technical idea of the present disclosure, and those skilled in the art to which the present disclosure pertains may make various modifications and variations without departing from the essential characteristics of the present disclosure. Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A method for tracking a pose of a non-rigid object in a manipulator system, the method comprising:
determining detection information for a non-rigid object based on at least one image data;
determining matching depth information for the non-rigid object based on the acquired at least one image data;
determining initial pose information for the non-rigid object based on the detection information and the matching depth information; and
tracking a pose of the non-rigid object.

2. The non-rigid object pose tracking method of claim 1, wherein:
the at least one image data is acquired using at least one camera included in a manipulator,
the determining the detection information comprises determining detection information for the non-rigid object using an object detection model; and
the detection information comprises one or more of:
a bounding box;
a class label;
a confidence score; and
a segmentation mask for the non-rigid object.

3. The non-rigid object pose tracking method of claim 2, wherein the determining the detection information for the non-rigid object using the object detection model comprises:
extracting a plurality of feature maps having different resolutions from the at least one image data; and
outputting one or more of:
the bounding box;
the class label;
the confidence score; and
the segmentation mask from the feature maps.

4. The non-rigid object pose tracking method of claim 1, wherein, when the non-rigid object is not detected from the at least one image data, the determining the detection information comprises:
adjusting a position of a manipulator; and
determining the detection information from at least one image data obtained based on an adjustment of the position of the manipulator.

5. The non-rigid object pose tracking method of claim 1, wherein the determining the matching depth information comprises:
determining RGB image data and depth image data for the non-rigid object from the at least one image data; and
determining the matching depth information based on image matching of the RGB image data and the depth image data.

6. The non-rigid object pose tracking method of claim 5, wherein the determining the matching depth information based on the image matching of the RGB image data and the depth image data comprises:
converting the depth image data based on a coordinate system of the RGB image data; and
aligning depth image data closest to the non-rigid object among the converted depth image data to the RGB image data.

7. The non-rigid object pose tracking method of claim 1, wherein the determining the initial pose information for the non-rigid object comprises:
determining an initial 3D point cloud for the non-rigid object and an initial normal vector for a surface formed by the initial 3D point cloud based on matching of the detection information and the matching depth information.

8. The non-rigid object pose tracking method of claim 1, wherein the tracking the pose of the non-rigid object comprises:
tracking the pose of the non-rigid object based on a geometric correspondence between the initial pose information for the non-rigid object and virtual 3D model information for the non-rigid object that has been previously stored;
determining a feature point and a normal vector geometrically corresponding to the initial pose information based on the virtual 3D model information; and
tracking the pose of the non-rigid object by referring to a rendered image determined based on the feature point and the normal vector.

9. The non-rigid object pose tracking method of claim 8, wherein the determining the feature point and the normal vector geometrically corresponding to the initial pose information based on the virtual 3D model information comprises:
determining the feature point and the normal vector using an iterative corresponding geometry (ICG) algorithm that optimizes geometric correspondence based on RGB-based matching and depth-based matching.

10. The non-rigid object pose tracking method of claim 8, wherein the tracking the pose of the non-rigid object by referring to the rendered image determined based on the feature point and the normal vector comprises:
determining a segmentation image for the non-rigid object based on rendering of the detection information;
determining an overlap ratio between the segmentation image and the rendered image; and
re-determining detection information for the non-rigid object when the overlap ratio is less than a predetermined threshold.

11. An apparatus for tracking a pose of a non-rigid object in a manipulator system, the apparatus comprising:
a computing device comprising a processor and a memory, wherein the memory is configured to store instructions that, when executed by the processor, are configured to cause the processor to:
determine detection information for a non-rigid object based on at least one image data;
determine matching depth information for the non-rigid object based on the acquired at least one image data;
determine initial pose information for the non-rigid object based on the detection information and the matching depth information; and
track a pose of the non-rigid object.

12. The non-rigid object pose tracking apparatus of claim 11, wherein:
the at least one image data is acquired using at least one camera included in a manipulator,
the computing device is configured to determine detection information for the non-rigid object using an object detection model, and
the detection information comprises one or more of:
a bounding box;
a class label;
a confidence score; and
a segmentation mask for the non-rigid object.

13. The non-rigid object pose tracking apparatus of claim 11, wherein, when the non-rigid object is not detected from the at least one image data, the computing device is configured to:
adjust a position of a manipulator; and
determine the detection information from at least one image data obtained based on an adjustment of the position of the manipulator.

14. The non-rigid object pose tracking apparatus of claim 11, wherein the computing device is configured to:
determine RGB image data and depth image data for the non-rigid object from the at least one image data; and
determine the matching depth information based on image matching of the RGB image data and the depth image data.

15. The non-rigid object pose tracking apparatus of claim 14, wherein the computing device is configured to:
convert the depth image data based on a coordinate system of the RGB image data; and
align depth image data closest to the non-rigid object among the converted depth image data to the RGB image data.

16. The non-rigid object pose tracking apparatus of claim 11, wherein the computing device is configured to determine an initial 3D point cloud for the non-rigid object and an initial normal vector for a surface formed by the initial 3D point cloud based on matching of the detection information and the matching depth information.

17. The non-rigid object pose tracking apparatus of claim 11, wherein the computing device is configured to:
track the pose of the non-rigid object based on a geometric correspondence between the initial pose information for the non-rigid object and virtual 3D model information for the non-rigid object that has been previously stored;
determine a feature point and a normal vector geometrically corresponding to the initial pose information based on the virtual 3D model information; and
track the pose of the non-rigid object by referring to a rendered image determined based on the feature point and the normal vector.

18. The non-rigid object pose tracking apparatus of claim 17, wherein the computing device is configured to:
determine the feature point and the normal vector using an iterative corresponding geometry (ICG) algorithm that optimizes geometric correspondence based on RGB-based matching and depth-based matching.

19. The non-rigid object pose tracking apparatus of claim 17, wherein the computing device is configured to:
determine a segmentation image for the non-rigid object based on rendering of the detection information;
determine an overlap ratio between the segmentation image and the rendered image; and
re-determine detection information for the non-rigid object when the overlap ratio is less than a predetermined threshold.

20. A non-transitory computer-readable recording medium storing a computer program that, when executed by a processor, has instructions for causing the processor to perform a mobility driving control method, comprising:
determining detection information for a non-rigid object based on at least one image data;
determining matching depth information for the non-rigid object based on the acquired at least one image data;
determining initial pose information for the non-rigid object based on the detection information and the matching depth information; and
tracking a pose of the non-rigid object.
